(19) United States
(12) Patent Application Publication
(10) Pub. No.: US 2015/0227954 A1
(43) Pub. Date: Aug. 13, 2015

(54) PUSH SYSTEM FOR MOBILE GAME PROMOTION AND THE METHOD OF PUSH SERVICE

(71) Applicant: NHN Entertainment Corporation, Seongnam-si (KR)

(72) Inventors: Jae-Woo JUNG, Seongnam-si (KR); Dong-Seong Lee, Seongnam-si (KR); Jae-Hyun Shin, Seongnam-si (KR)

(21) Appl. No.: 14/614,270

(22) Filed: Feb. 4, 2015

(30) Foreign Application Priority Data
Feb. 7, 2014 (KR) 10-2014-0014114

(51) Int. Cl. G06Q 30/02; H04L 29/08

(52) U.S. Cl. CPC G06Q 30/0209; H04L 67/26

(57) ABSTRACT

A system and a method for mobile game promotion are disclosed. The push system for mobile game promotion includes a push server and a database server. The push server transmits a promotion message for a mobile game to target user device, monitors whether a user of the target user device performed a predetermined task in the game promotion message, and provides the user with rewards corresponding to performed tasks. The database server stores data provided by the user device and the push server.

### CROSS REFERENCE TO RELATED APPLICATIONS

This application claims priority from and the benefit of Korean Patent Application No. 10-2014-0014114, filed on Feb. 7, 2014, which is hereby incorporated by reference for all purposes as if fully set forth herein.

### BACKGROUND

1. Field

Exemplary embodiments of the present invention relate to a system and a method for promoting mobile games. Exemplary embodiments of the present invention relate to a system and a method for promoting a mobile game using a push server.

2. Discussion of the Background

Recently, information technologies related to computer systems have brought rapid progress in the game industry. While conventional computer games include arcade games or video games, various other types of games are being introduced along with the development of multimedia technology and network technology. For example, wide propagation of mobile data network communication devices and wireless internet introduced a new type of game, mobile game.

Cloud game service technology, providing game service for a plurality of user devices supporting network and computation functions, has attracted public attention. A server providing such cloud game service receives user inputs from user devices, performs game functions corresponding to the user inputs, and provides results of the game functions for the user devices. The server may enable users to enjoy high quality games with mobile devices with minimal specification.

Game service providers have conventionally attracted new subscribers through advertisement at an early stage, and the initial subscribers growing interest in the game could introduce the game to acquaintances, family, and friends, which could provide an opportunity for the game service providers to expand subscribers. However, the conventional marketing approach has limits. First, the conventional advertisement via mass media is costly. Second, the conventional advertisement may be inefficient because not every game service provider may draw public attention despite the costly long term advertisement in a competitive industry where thousands of mobile games are introduced everyday.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide a system and method for promoting mobile games by monitoring whether a user performed a predetermined task and rewarding the user based on the result of task performance.

Additional features of the invention will be set forth in the description which follows, and in part will be apparent from the description, or may be learned by practice of the invention.

An exemplary embodiment of the present invention discloses a push system for mobile game promotion including a push server and a database server. The push server transmits a promotion message for a mobile game to a target user device, monitors whether a user of the target user device performed a predetermined task in the game promotion message, and provides the user with rewards corresponding the tasks performed. The database server stores data provided by the user device and the push server.

An exemplary embodiment of the present invention discloses a method for promoting a mobile game including generating a game promotion message for the mobile game, selecting target users to send the game promotion message, transmitting the game promotion message in a push method to user devices of the selected target users; and providing the user device with a reward corresponding to a predetermined task when the users completed the predetermined task.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the disclosure and are incorporated in and constitute a part of this specification, illustrate exemplary embodiments of the disclosure, and, together with the description, serve to explain the principles of the disclosure.

FIG. 1 is a schematic diagram illustrating a push system for game promotion according to an exemplary embodiment of the present invention.

FIG. 2 is a block diagram illustrating an internal structure of a push system according to an exemplary embodiment of the present invention.

FIG. 3 is a flow chart illustrating a method for mobile game promotion service according to an exemplary embodiment of the present invention.

### DETAILED DESCRIPTION OF THE ILLUSTRATIVE EMBODIMENTS

The present disclosure is described more fully hereinafter with reference to the accompanying drawings, in which embodiments of the present disclosure are shown. The present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. In the drawings, the sizes and relative sizes of layers and regions may be exaggerated for clarity.

It will be understood that, although the terms first, second, third etc. may be used herein to describe various elements, components, and other aspects, these elements, components, and/or other aspects should not be limited by these terms. These terms are only used to distinguish one element, component, or aspect from another. Thus, a first element, component, or other aspect discussed below could be termed a second element, component, or other aspect without departing from the teachings of the present disclosure.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, with reference to the drawings, exemplary embodiments of the present disclosure will be described in detail.

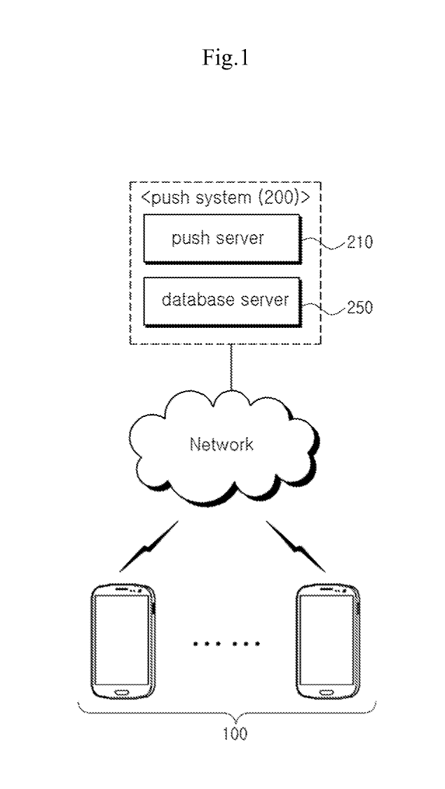

FIG. 1 is a schematic diagram illustrating a push system for game promotion according to an exemplary embodiment of the present invention.

Referring to FIG. 1, an exemplary embodiment of a push system 200 for mobile game promotion is configured to be connected to user devices 100 via a network. When the push system 200 sends a game promotion message to one or more user devices 100, a user device 100 may display the game promotion message on its idle screen. If the user who received the game promotion message would like to obtain detailed information of the game promotion, the user may access the push system 200 which may provide detailed information for the user through the user device 100. The push system 200 may provide rewards to a user based on the user's activities.

The push system 200 according to an exemplary embodiment of the present invention may monitor participation rate of each promotion based on user response rate or access rate. Using the data accumulated by monitoring the user participation rate of previous promotions, the push system 200 may then plan promotions customized to target user groups. The push system 200 and push service provided by the push system 200, according to an exemplary embodiment of the present invention, may attract voluntary and active participation to the game promotions by providing various rewards based on user activities.

A user device 100 may be a computing device capable of wireless data communication, for example, a smartphone, a cellular phone, a MP3, a portable game device, a TV, a laptop computer, tablet device, PMP(Personal Media Player), PDA(Personal Digital Assistants), and the like.

An exemplary embodiment of the push system 200 may include a push server 210 which sends a game promotion message as a push message to the user device 100, and determine whether the user participated in the promotion to provide a reward. The push system 200 may also include a database server 250 which may store information provided by the user device 100 and information generated by the push server 210.

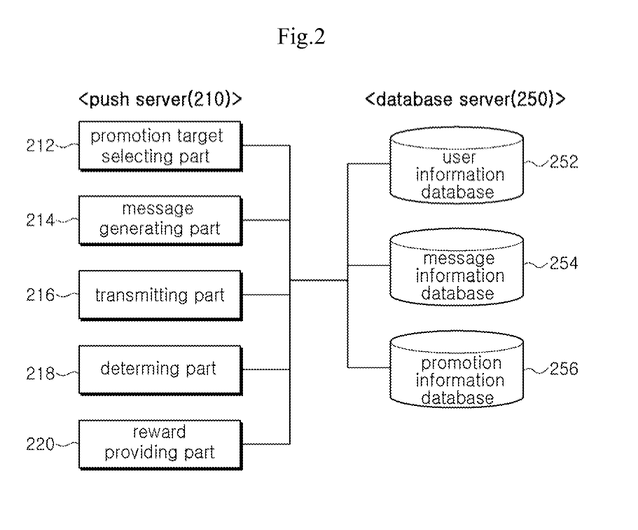

FIG. 2 is a block diagram illustrating an internal structure of the push system 200 in FIG. 1 according to an exemplary embodiment of the present invention.

As illustrated in FIG. 2, an exemplary embodiment of the push system 200 may include a push server 210 and database server 250. Although depicted as two servers in FIG. 2, components of push system 200 may be provided in a single server, do not have to have the same logical or physical address, and may be located in different locations and associated with different addresses, such as different IP addresses.

The push server 210 may include a promotion target selecting part 212, a message generating part 214, a push transmitting part 216, a determining part 218, and a reward providing part 220. The database server 250 may include a user information database 252, a message information database 254, and a game promotion information database 256.

The promotion target selecting part 212 may select target users to whom the game promotion message will be sent. Such target selection may be implemented based on the user information stored in the user information database 252 in various ways according to the promotion plan. For example, the target users may be selected based on their personal information, e.g., ages, sex, or residence, whether a particular game is installed on a user device of each users, or combinations of such information.

The message generating part 214 may generate a game promotion message to send to the user device 100 as a push service. The game promotion message may include text or a push notification. The game promotion message may have, for example, a confirmation key which the user can use to access detailed information of the promoted game. When a user selects the confirmation key in the game promotion message sent by the push system 200, the user device 100 connects to the push system 200, and the push system 200 provides detailed information of the promoted game. The game promotion message may include, for example, a link for installation of the promoted game or automatic execution of the promoted game. In some embodiments, the push notification can be generated by the messaging generating part 214 dependent on a request from the user device indicating its willingness to accept, or a specific request for, a game promotion message.

The push transmitting part 216 may transmit the game promotion message generated by the message generating part 214 to the user devices 100 of the target users selected by the promotion target selecting part 212. The message transmission may be executed in a push method. For example, an exemplary embodiment of the push transmitting part 216 may be implemented by an always-on method that supports real time push service, or NRPCA(Network Requested Packet data protocol Context Activation) method where a static or dynamic IP address is assigned without PDP(Packet Data Protocol) context activation to supports push service.

The determining part 218 may receive an acknowledgment message from the user device 100 to determine whether the user device that received the game promotion message accessed the push system 200 and whether the user performed a predetermined task, for example, reading detailed information of the promotion or installing the promoted game.

If the determining part 218 determines that the user has performed the predetermined task, the reward providing part 220 may provide the user device 100 with a reward corresponding to the performed task. The reward may be, for example, cash, points, contents, or game items according to the promotion, but aspects of the invention are not limited thereto.

The user information database 252 may store personal information of the users. The personal information may be used for identifying which users and user devices 100 will be sent a game promotion message. The personal information may include, for example, users' name, sex, age, and mobile number. The personal information may be input by the user during a registration process for the push service, or provided by user's approval to share personal information stored for a game service to which the user has registered.

The message information database 254 may store the game promotion message generated by the message generating part 214.

The promotion information database 256 may store promotion information for each game, standards for selecting target users for each game, information on rewards according to each promotion, and number of user acknowledges, but aspects of the invention are not limited thereto.

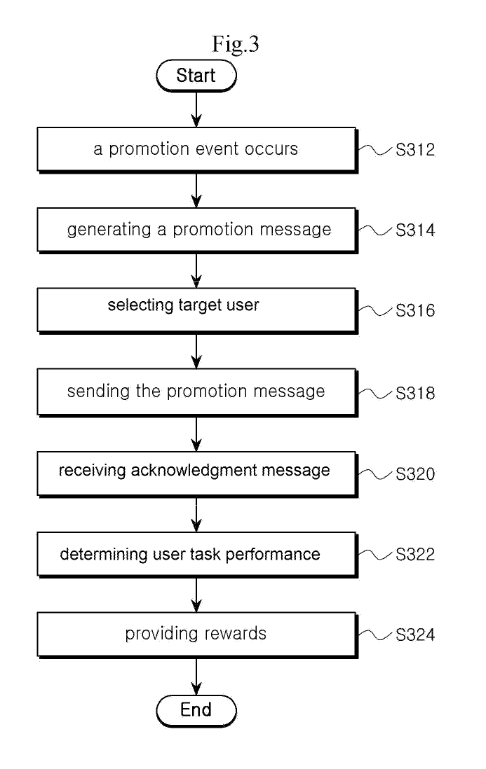

Referring to FIG. 3, an exemplary embodiment of a push service method for mobile game promotion will be described.

FIG. 3 is a flow chart illustrating a method for mobile game promotion service according to an exemplary embodiment of the present invention.

As illustrated in FIG. 3, when a game promotion event occurs (S312), the push system 200 may generate a game promotion message that will be sent to user devices (S314). The game promotion message may include a confirmation key the user can use to access detailed information of the promoted game. When a user selects the confirmation key in the game promotion message sent by the push system 200, the user device 100 connects to the push system 200, and the push system 200 may provide detailed information of the promoted game. The game promotion message may provide, for example, a link for installation of the promoted game or automatic execution of the promoted game.

The push system 200 may then select target users to send the game promotion message (S316). Such target selection may be implemented based on the user information stored in the user information database 252 in various ways according to the promotion plan. For example, the target users may be selected based on their personal information, e.g., ages, sex, or residence, whether a particular game is installed on a user device of each user, or combinations of such information, but aspects of the invention are not limited thereto.

The push system 200 may successively send the game promotion message in a push method to the user devices of the selected target users (S318), and may receive acknowledgment message from one or more user devices 100 (S320).

The push system 200 may then determine whether the user device that received the game promotion message accessed the push system 200 and whether the user performed a predetermined task, e.g., reading the detailed information of the promotion or installing the promoted game (S322). If it is determined that the user has performed the predetermined task, the push system 200 may provide the user device 100 with a reward corresponding to the performed task.

As described in detail above, the present invention provides push system and push service method that allows game providers to monitor participation rate of the each game promotion based on user response rate or access rate, to develop game promotion plans based on the gathered data of the previous promotion and to customize target user group using the accumulated data. The push system and push service method according to an exemplary embodiment of the present invention may attract voluntary and active participation to game promotion by providing rewards to users in various ways based on the user activities. Additionally, by providing a push server in this manner, the push server can operate more efficiently as it can provide focused promotion of games. For example, the storage requirements for the server can be reduced compared to a system that does not perform the monitoring, for example, as described herein.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A push system for mobile game promotion comprising:
a push server to transmit a game promotion message to a target user device, the push server monitoring whether a user of the target user device performed a predetermined task in the game promotion message and providing the user with one or more rewards corresponding to the performed predetermined task; and
a database server to store data provided by the user device and the push server.

2. The push system of claim 1, wherein the game promotion message comprises at least one of digital content associated with a game and a push notification.

3. The push system of claim 2, wherein the game promotion message comprises a confirmation key, the user device accessing the push system to obtain information of the game promotion by use of the confirmation key.

4. The push system of claim 3, wherein the game promotion message, in response to the use of the confirmation key, comprises at least one of a link for installation or execution of a game associated with the game promotion message.

5. The push system of claim 1, wherein the push server comprises:
a message generating part to generate the game promotion message;
a promotion target selecting part to select a target user device to send the game promotion message;
a push transmitting part to transmit the game promotion message to the target user device;
a determining part to determine whether the target user device has performed the predetermined task; and
a reward providing part to provide the target user device with a reward corresponding to the predetermined task when the target user device has completed the predetermined task.

6. The push system of claim 5, wherein the determining part receives an acknowledgment message for the game promotion message from the user device.

7. The push system of claim 5, wherein the determining part determines whether the target user device which received the game promotion message has accessed the push server.

8. The push system of claim 1, wherein the database server comprises:
a user information database to store user information;
a message information database to store the game promotion message; and
a game promotion information database to store information of each game promotion.

9. The push system of claim 8, wherein the user information is input by the user during a registration process of the push service.

10. The push system of claim 8, wherein the user information is provided based on an approval of sharing user information of users who have installed a game.

11. The push system of claim 8, wherein the game promotion information comprises a standard for selecting the target user for each game promotion, information associated with a reward for each promotion, and user response information.

12. A method of push service for mobile game promotion comprising:
generating a game promotion message for a mobile game;
selecting a target user to send the game promotion message;
transmitting the game promotion message in a push method to user device of the selected target user; and
providing the user device with a reward corresponding to a predetermined task performed by the user.

13. The method of claim 12, wherein the game promotion message comprises a confirmation key,
wherein a user device accesses a push system to obtain information of the game promotion using the confirmation key.

14. The method of claim 12, further comprising receiving an acknowledgment message for the game promotion message from the user device.
